(19) United States
(12) Patent Application Publication
(10) Pub. No.: US 2026/0175192 A1
(43) Pub. Date: Jun. 25, 2026

(54) POROUS, CRYSTALLINE COMPOUND

(71) Applicant: Christian-Albrechts-Universitaet zu Kiel, Kiel (DE)

(72) Inventors: Norbert Stock, Kiel (DE); Bastian Achenbach, Kiel (DE); Erik Svensson Grape, Stockholm (SE); Andrew Ken Inge, Uppsala (SE)

(21) Appl. No.: 18/849,616

(22) PCT Filed: Mar. 20, 2023
(86) PCT No.: PCT/DE2023/100212

§ 371 Date: Sep. 23, 2024

(30) Foreign Application Priority Data
Mar. 23, 2022 (DE) 10 2022 106 916.8

(51) Int. Cl. B01J 20/22; B01D 53/02; B01D 67/00; B01D 71/02; C07F 5/06

(52) U.S. Cl. CPC B01J 20/226; B01D 53/02; B01D 67/0088; B01D 71/022; B01D 71/025; C07F 5/069

(57) ABSTRACT

A porous, crystalline compound according to the following formula: [Al₂₄(OH)₅₆(RCOO)₁₂]X₄, wherein R can be hydrogen or a branched or non-branched, saturated or unsaturated, functionalized or non-functionalized hydrocarbon chain with a length of 1 to 8 carbon atoms, and wherein the functionalization is selected from the group —OH, —F, —Cl, —Br, —I, —SH, —NO₂, —CHO, —COOH, —SO₃H, —NH₂, and wherein R can be the same or different and wherein X can be the same or different, and wherein X is an anion, preferably a monovalent anion, particularly preferably a monovalent anion selected from the group Cl⁻, Br⁻, I⁻, OH⁻, SCN⁻, NO₃⁻, HSO₄⁻, HS⁻, ClO₃⁻, and ClO₄⁻ or mixtures of these anions. The invention also relates to a method for producing porous, crystalline compounds and to uses of the porous, crystalline compound according to the invention.

The invention relates to porous, crystalline compounds and a method for their preparation and uses.

Due to their defined structure, crystalline porous compounds with defined porosity are promising candidates for use in the storage and separation of liquids or gases, for water sorption (also in connection with the regulation of humidity, water extraction and cooling), as catalysts, adjuvants, carrier materials or solubilizers, as ion exchangers, for the adsorption of dyes, as fillers for membranes and as a starting material for), as catalysts, adjuvants, carrier materials or solubilizers, as ion exchangers, for the adsorption of dyes, as fillers for membranes and as starting materials for the synthesis of highly pure metal oxides or hydroxides.

Metal-organic frameworks (MOFs) have a lattice structure and are made up of metal-based inorganic units, often oxides or hydroxides, which are connected via organic linker molecules.

In the article Li et al.: “Recent advances in aluminum-based metal-organic frameworks (MOF) and its membrane applications”, Journal of Membrane Science, Volume 615, December 2020, 118493 https://doi.org/10.1016/j.memsci.2020.118493 provides an overview of the known aluminum-based metal-organic frameworks (MOFs) and their applications.

In Jung, Kyung-Won et al.: “Green synthesis of aluminum-based metal organic framework for the removal of azo dye acid black 1 from aqueous media”, Journal of Industrial and Engineering Chemistry, Vol. 67, 2019, pp. 316-325], aluminum-based MOFs with dicarboxylate linkers that link via both carboxylate groups are presented. This MOF crystallizes in the characteristic MIL-53 structure, which the authors call the butterfly-like structure. Due to their good ability to adsorb the dye Acid Black 1, the MOFs in question are proposed as adsorbents for the treatment of wastewater.

Mani, Mohan Raj et al.: “Enhanced nucleation of polypropylene by metal-organic frameworks (MOFs) based on aluminum dicarboxylates: influence of structural features, RSC Advances, 2016, Vol. 6, pp. 1907-1912], aluminum-based MOFs are also described in the characteristic MIL-53 structure. The organic linker has carbon chains with a length between 2 and 10 carbon atoms.

Porous crystalline salts with MOF-like permanent porosity are known from Gosselin et al., “Elaboration of Porous Salts” J. Am. Chem. Soc. 2021, 143, 37, 14956-14961.

Smolders et al.: “A precursor method for the synthesis of new Ce(IV) MOFs with reactive tetracarboxylate linkers”, Chemical Communications 2018, 54, 876-879; DOI https://doi.org/10.103 9/C7CC08200B reports the use of molecular metal-oxygen carboxylate clusters as a starting material/precursor for the preparation of Ce(IV) MOFs, where the framework is formed by exchanging the monocarboxylate ions for dicarboxylate ions.

WO 2021/048 741 A3 describes a metal-organic framework (MOF) as part of a heterogeneous catalyst system for the oligomerization of olefins, whose activity is higher by a factor of 20 than that of conventional homogeneous catalysts. The system can be easily removed compared to monomolecular catalysts. The MOF contains at least one ligand with an N-heteroaromatic ring.

In Bagherpour et al.: “Investigating the Performance of Carboxylate-Alumoxane Nanoparticles as a Novel Chemically Functionalized Inhibitor on Asphaltene Precipitation”, ACS Omega 2020, 5, 16149, methoxyacetate-functionalized alumoxanes are used to prevent the precipitation of asphalt in crude oils.

EP 22 34 922 B1 describes the production of acicular highly pure boehmite (aluminum hydroxide oxide) from the precursor Al(OH)w(R1)x(R2)y(R3)z, which can be added to polymers for reinforcement, wherein R1, R2 and R3 can be different carboxylates.

U.S. Pat. No. 8,658,562 B2 and the U.S. Pat. No. 8,907,114 B2 describe a method for producing a MOF based on aluminum oxide with carboxylate ligands or azobenzene carboxylate ligands in non-aqueous media at temperatures above 100° C. The material is intended for use in the storage and separation of gases or liquids. The use of non-aqueous media in the production of the corresponding MOFs and temperatures of more than 100° C. are disadvantageous.

Reinsch et al.: “A new Al-MOF based on a unique column-shaped inorganic building unit exhibiting strongly hydrophilic sorption behavior”, Chemical Communications 2012, 48, 9486-9488; DOI https://doi.org/10.1039/C2CC34909D describes the preparation of an Al-MOF based on known aluminum hydroxide oxide ions bridged by 2-aminoterephthalate ligands.

The invention's purpose is to provide new porous crystalline compounds.

In a further aspect, the object of the invention is to provide a process for the preparation of new porous crystalline compounds.

Furthermore, the object of the invention is a process for the preparation of the new porous crystalline compounds, which can be carried out in aqueous media and at reaction temperatures between room temperature and 140° C. with yields of more than 50%.

In a particular aspect, it is the task of the invention to provide a process for the production of new porous crystalline compounds which can be carried out in a one-pot reaction.

The object of the invention is solved by porous crystalline compounds or porous crystalline compound according to the following formula:

$$[ {{Al}_{24} ( OH )}_{56} {( RCOO )}_{12} ] {X}_{4}$$

wherein R can be hydrogen or a branched or unbranched, saturated or unsaturated, functionalized or non-functionalized hydrocarbon chain with a length of 1 to 8 carbon atoms and wherein the functionalization is selected from the group —OH, —F, —Cl, —Br, —I, —SH, −NO₂, —CHO, —COOH, —SO₃H, —NH₂ and wherein R may be the same or different and wherein X may be the same or different and is an anion, preferably a monovalent anion, more preferably a monovalent anion selected from the group Cl⁻, Br⁻, I⁻, OH⁻, SCN⁻, NO₃⁻, HSO₄−, HS⁻, ClO₃⁻, and ClO₄⁻ or mixtures of said anions.

In one particular aspect, the object of the invention is solved by porous crystalline compounds that have cationic [Al₂₄(OH)₅₆(RCOO)₁₂]⁴⁺-cages, where the cationic [Al₂₄(OH)₅₆(RCOO)₁₂]⁴⁺-cages consist of 8 trinuclear building units of the composition {Al₃(μ₃OH)(μ₂—OH)₃^{}5+}, 24 OH⁻ and 12 RCOO⁻ ions and where each of the three aluminum cations Al³⁺ coordinates octahedrally with 5 OH⁻ and one RCOO⁻ via an oxygen atom and wherein the {Al₃(μ₃—OH)(μ₂—OH)₃^{}5+} structural units are arranged at the corners of a cube and wherein neighboring {Al₃(μ₃—OH)(μ₂—OH)₃^{}5+}-structural units are linked by 2 OH⁻ and 1 RCOO⁻.

In this case μ₃—OH means that an OH ion bridges three aluminum cations Al³⁺ and μ₂—OH means two.

In a further special aspect, the cationic [Al₂₄(OH)₅₆(RCOO)₁₂^{]4+} cages are arranged in a face-centered cubic manner.

In a further aspect, the crystalline porous compound according to the invention contains monovalent anions which occupy ⅔ of the octahedrally arranged free sites resulting from the body-centered cubic arrangement of the cationic [Al₂₄(OH)₅₆(RCOO)₁₂^{]4+}-cages.

In a particular aspect, the problem of the invention is solved by porous crystalline compounds selected from the group consisting of [Al₂₄(OH)₅₆(CH₃COO)₁₂]Cl₄, [Al₂₄(OH)₅₆(CH₃COO)₁₂]Br₄, [Al₂₄(OH)₅₆(CH₃COO)₁₂]I₄, [Al₂₄(OH)₅₆(CH₃COO)₁₂](OH)₄, [Al₂₄(OH)₅₆(CH₃COO)₁₂](SCN)₄, [Al₂₄(OH)₅₆(CH₃COO)₁₂](NO₃)₄, [Al₂₄(OH)₅₆(CH₃COO)₁₂](HSO₄)₄, [Al₂₄(OH)₅₆(CH₃COO)₁₂](HS)₄, [Al₂₄(OH)₅₆(CH₃COO)₁₂](ClO₃)₄, [Al₂₄(OH)₅₆(CH₃COO)₁₂](ClO₄)₄, [Al₂₄(OH)₅₆(C₂H₅COO)₁₂]Cl₄, [Al₂₄(OH)₅₆(HCOO)ₓ(CH₃COO)₁₂₋ₓ]Cl₄ with x=1; 2, [Al₂₄(OH)₅₆(HSCH₂COO)₁₂]Cl₄, [Al₂₄(OH)₅₆(CH₃COO)₁₂]Cl_{y}Br_{4-y} with y=0 to 4, [Al₂₄(OH)₅₆(CH₃COO)₁₂]Br_{y}I_{4-y} with y=0 to 4.

In a further aspect, the problem of the invention is solved by a method for producing porous crystalline compounds comprising the following steps:
i. providing an aqueous solution of an aluminum salt;
ii. adding the carboxylic acid or the mixture of carboxylic acids or their salts;
iii. optionally adding a water-soluble salt of the anion or the mixture of different anions X;
iv. tempering the mixture from step iii at RT to 140° C. for 4 weeks to 2 minutes;
v. optionally, allowing the mixture to cool to room temperature;
vi. separating the solid from the solution, for example by filtering, spray drying or centrifugation;
vii. washing the resulting solid with water and/or alcohols;
viii. drying the washed solid.

Water-soluble salts are known to those skilled in the art and include, for example, sodium, potassium or ammonium salts. In a particular embodiment of the process, the anion or anions X of the water-soluble salt from step (iii) are selected from Cl⁻, Br⁻, I⁻, OH⁻, SCN⁻, NO₃⁻ HSO₄⁻, HS⁻, ClO₃⁻, and ClO₄^{- or mixtures of these anions.}

The synthesis of the compounds according to the invention can be carried out as a very rapid one-pot synthesis in aqueous media with very favorable starting materials. Advantageously, the tempering step (iv) can also be carried out in the flow reactor.

The compounds according to the invention [Al₂₄(OH)₅₆(R—COO)₁₂]X₄ where R is hydrogen or a branched or unbranched, saturated or unsaturated, functionalized or non-functionalized hydrocarbon chain having a length of 1 to 8 carbon atoms and wherein the functionalization is selected from the group consisting of —OH, —F, —Cl, —Br, —I, —SH, —NO₂, —CHO, —COOH, —SO₃H, —NH₂ and wherein R may be the same or different and wherein X may be the same or different and may be an anion, preferably a monovalent anion, preferably a monovalent anion selected from the group Cl⁻, Br⁻, I⁻, OH⁻, SCN⁻, NO₃⁻, HSO₄⁻, HS⁻, ClO₃⁻, and ClO₄⁻ or mixtures of these anions, can be assigned to the group of porous metal carboxylates, which also includes the so-called metal-organic frameworks (MOFs). In the latter type of compound, an organic ligand acts as a “linker” between the inorganic building blocks. In the case of the invention, the carboxylate ions (RCOO⁻) coordinate to aluminum ions without bridging the inorganic building units. The cationic aluminum carboxylate building units crystallize with various anions to form highly crystalline salts. Compared to non-crystalline porous materials, the new porous crystalline aluminum carboxylates have pores that are very well defined in terms of shape and size. These defined properties make these compounds very interesting for applications in the field of storage and separation of liquids or gases, catalysis, as adjuvants or solubilizers and as starting materials for the synthesis of highly pure metal oxides or hydroxides, as well as a starting material for MOF syntheses by ligand-linker exchange.

The X-ray diffraction patterns of the compounds according to the invention [Al₂₄(OH)₅₆(RCOO)₁₂]X₄ show the uniqueness of this type of compound. FIG. 1 shows a representation of the structure of the cationic cages. The structure of [Al₂₄(OH)₅₆(CH₃COO)₁₂]Cl₄ is described below as an example.

Al³⁺, OH⁻ and acetate ions (CH₃COO⁻) form a cationic cubic cage of the composition [Al₂₄(OH)₅₆(CH₃COO)₁₂]4+. Each aluminum cation (Al³⁺) is surrounded (coordinated) octahedrally by 5 hydroxide ions (OH⁻) and one oxygen atom of an acetate ion (CH₃COO⁻) The hydroxide ions bridge (μ₂—OH und μ₃—OH) two or three Al³⁺-Ions respectively (FIG. 1 a). The structure of the cationic cage is obtained by linking eight trinuclear units of composition {Al₃(μ₃—OH)(μ₂—OH)₃^{}5+}, located at the corners of a cube (FIG. 1 b) via 24 OH⁻ and 12 CH₃COO⁻ ions (FIG. 1 c). In this process, neighboring trinuclear units are linked via two 2 OH⁻ Ions und 1 CH₃COO⁻ ion.

In the crystal structure, the cationic cages form a body-centered cubic arrangement. The arrangement of the cationic cages in the unit cell is shown in FIG. 2.

The anions are randomly distributed in the octahedral gaps, with only ⅔ of the octahedral gaps being occupied. The unit cell contains two formula units. The lattice parameters of the compounds are given in Table 1.

The presence of highly ordered crystalline structures is clearly recognizable in the powder X-ray diffraction patterns by the low half-width of the reflexes, the high signal-to-background ratio at high diffraction angles (° 2θ) and the absence of the amorphous halo (FIGS. 3, 4, 5 and 6). The different ionic radii of the anions X and the different size of R lead to distinct shifts in the reflex positions (FIGS. 3, 4 and 5). Reaction temperatures between room temperature (25° C.) and 140° C. lead to the result according to the invention (FIG. 6). The formation of the compound according to the invention can be clearly recognized from the specific reflexes in the powder diffractograms.

TABLE 1
Crystal structure parameters of [Al₂₄(OH)₅₆(RCOO)₁₂]X₄,
which were refined using the Rietveld-method (*1) or the
Le Bail-method (*2) on the basis of X-ray powder diffraction data.

| | | | | a = b = c (Å); | | |
|---|---|---|---|---|---|---|
| | X⁻ | R | space group | α = β = γ (°) | Z | GoF |
| 1 | CI^{-*1} | -CH₃ | Im3̅m | 16.79533(11); 90 | 2 | 3.- 3 |
| 2 | Br^{-*2} | | | 16.8925(2); 90 | | 4.6 |
| 3 | I^{-*2} | | | 16.9604(12); 90 | | 3.0 |
| 4 | OH^{-*2} | | | 16.6305(8); 90 | | 3.3 |
| 5 | SCN^{-*2} | | | 16.8386(3); 90 | | 5.8 |
| 6 | NO₃^{-*2} | | | 16.9052(2); 90 | | 4.8 |
| 7 | HSO₄^{-*2} | | | 16.6923(3); 90 | | 3.1 |
| 8 | HS^{-*2} | | | 16.6335(7); 90 | | 4.1 |
| 9 | CIO₃^{-*2} | | | 16.7171(5); 90 | | 5.2 |
| 10 | CIO₄^{-*2} | | | 16.6962(5); 90 | | 5.5 |
| 11 | Cl^{-*2} | -C₂H₅ | | 16.7999(3); 90 | | 3.8 |
| 12 | Cl^{-*2} | -H, -CH₃ | | 16.7784(18); 90 | | 3.2 |

The new compounds [Al₂₄(OH)₅₆(RCOO)₁₂]X₄ are highly effective adsorbents for gases and vapors (Table 2). Nitrogen sorption measurements at 77 K yielded a specific surface area of up to 940 m2/g. The water adsorption properties vary greatly with the activation temperature and the anion (X). A maximum water uptake of 0.46 g/g is observed for the OH⁻ containing sample.

TABLE 2
Specific surface areas determined by nitrogen sorption
measurements (77K) and maximum water absorption capacities
of [Al₂₄(OH)₅₆(RCOO)₁₂]X₄ determined by means of
water vapor sorption measurements (298K).

| | | | Specific | Maximum water |
|---|---|---|---|---|
| | | | surface | absorption |
| | X⁻ | R | (m²/g) | (g/g) |
| 1 | Cl⁻ | —CH₃ | 490 | 0.32 |
| 2 | Br⁻ | | 190 | 0.14 |
| 3 | I⁻ | | 350 | 0.33 |
| 4 | OH⁻ | | 940 | 0.46 |
| 5 | SCN⁻ | | 410 | 0.23 |
| 6 | NO₃⁻ | | 260 | 0.33 |
| 7 | HSO₄⁻ | | 910 | 0.35 |
| 8 | HS⁻ | | 840 | 0.51 |
| 9 | ClO₃⁻ | | 810 | 0.46 |
| 10 | ClO₄⁻ | | 900 | 0.47 |
| 11 | Cl⁻ | —C₂H₅ | 650 | 0.31 |
| 12 | Cl⁻ | —H, —CH₃ | 320 | |

The new compounds can be prepared as dispersions with particle sizes in the range of 100-1000 nm (Table 3). This is of interest for coating substrates or incorporating them into polymers (mixed-matrix membranes).

TABLE 3
Hydrodynamic particle diameters of [Al₂₄(OH)₅₆(RCOO)₁₂]X₄,
determined by dynamic light scattering, as a function of
composition and reaction conditions (a to g (see synthesis)).

| | | | | Hydrodynamic |
|---|---|---|---|---|
| | | | | particle |
| | X⁻ | R | Synthesis conditions | diameter (nm) |
| 1a | Cl⁻ | —CH₃ | 2 h, 70° C.; Glass reactor | 493 ± 103 |
| 1b | Cl⁻ | | 2 h, 80° C.; Glass reactor | 475 ± 69 |
| 1c | Cl⁻ | | 2 h, 90° C.; Glass reactor | 573 ± 54 |
| 1d | Cl⁻ | | 2 h, 100° C.; Glass reactor | 480 ± 120 |
| 1e | Cl⁻ | | 5 min, 95° C.; Flow reactor | 436 ± 54 |
| 1f | Cl⁻ | | 2 h, rf; 10 L - Round bottom | 538 ± 133 |
| | | | flask | |
| 1g | Cl⁻ | | 48 h, 140° C.; Steel autoclave | 236 ± 67 |
| 2 | Br⁻ | | 2 h, 90° C.; Glass reactor | 639 ± 33 |
| 3 | I⁻ | | | 810 ± 65 |
| 4 | OH⁻ | | | 167 ± 44 |
| 5 | SCN⁻ | | | 865 ± 110 |
| 6 | NO₃⁻ | | | 734 ± 73 |
| 7 | HSO₄⁻ | | | 151 ± 37 |
| 8 | HS⁻ | | | 273 ± 40 |
| 9 | ClO₃⁻ | | | 597 ± 35 |
| 10 | ClO₄⁻ | | | 252 ± 81 |
| 11 | Cl⁻ | —C₂H₅ | | 170 ± 38 |
| 12 | Cl⁻ | —H, | | 181 ± 49 |
| | | —CH₃ | | |

The new compounds [Al₂₄(OH)₅₆(RCOO)₁₂]X₄ are very suitable as anion adsorbents due to their structure and high positive surface charge. For example, anionic dyes can be quickly and effectively removed from ethanolic and aqueous solutions by adsorption. Accordingly, the compounds could also be suitable as a substrate for the production of pigments. Furthermore, the adsorption of anionic molecules (inorganic and organic), for example pollutants from water, is possible.

### Material and Methods

### Methods

Information on chemicals and equipment used is summarized in Tables 4 and 5.

TABLE 4
Chemicals used, manufacturers and purities.

| Chemical | Purity/% | Manufacturer |
|---|---|---|
| Formic acid | 99-100% | BASF |
| Aluminum chloride | 99% | Alfa Aesar GmbH & |
| hexahydrate | | Co KG |
| Aluminiumnitrat- | 98% | abcr GmbH |
| Nonahydrat | | |
| Aluminiumsulfat- | 99% | Bernd Kraft GmbH |
| Octadecahydrat | | |
| Deuterium oxide | 99.9% | Deutero GmbH |
| Ethanol | 98% | Walter-CMP GmbH & |
| | | Co. KG |
| Acetic acid | >99% | VWR International GmbH |
| Methanol | chemically | Walter-CMP GmbH & |
| | clean | Co. KG |
| Sodium -Bromid | 99% | Merck KGaA |
| Sodium chlorate | 97% | Merck KGaA |
| Sodium deuteroxide, | 99.5% | Deutero GmbH |
| 40 wt % | | |
| Sodium hydroxide | 99% | Grussing GmbH |
| Sodium iodide | 99% | abcr GmbH |
| Sodium metalloaluminate | technical | Sigma-Aldrich GmbH |
| Sodium perchlorate | 98% | Fluka |
| monohydrate | | |
| Sodium sulfide hydrate | >60% | Sigma Aldrich GmbH |
| | (<40% H₂O) | |
| Sodium thiocyanate | 97% | Merck KGaA |
| Propionic acid | 99% | Grüssing GmbH |
| Thioglycolic acid | 97% | Alfa Aesar GmbH & |
| | | Co KG |

TABLE 5
Measurement methods and equipment used.

| Method/instrument type | Device used |
|---|---|
| X-ray powder | Stadi P-Combi diffractometer from STOE, |
| diffractometer | equipped with a MYTHEN 1K detector, |
| | Cu Kα₁ radiation |
| 3D electron | JEOL JEM2100, equipped with a Timepix |
| diffractometer | detector from Amsterdam Scientific |
| | Instruments |
| ¹H-NMR-Spectrometer | DRX 500 from Bruker |
| Dynamic light | Delsa Nano C from Beckman Coulter |
| scattering | |
| Centrifuge | Allegra 64R from Beckman Coulter micro |
| | centrifuge Gusto from Heathrow Scientific |
| Gas sorption | BELSORP-max from BEL Japan |
| | BELSORP-mini from BEL Japan |
| Hot plate with magnetic | MR Hei-Tec from Heidolph |
| stirrer | |
| Flow reactor | MR Hei-Tec from Heidolph, |
| | Syringe pump LA-100 from HLL GmbH, |
| | Teflon ® -tubing (inner |
| | diameter = 1.6 mm) |

### Synthesis Instructions:

1a-d) Preparation of [Al₂₄(OH)₅₆(CH₃COO)₁₂]Cl₄ in a 14 mL Duran® Glass Reactor at a) 70° C., b) 80° C., c) 90 C,d) 100° C.:

In a 14 mL Duran® glass reactor, 1.6 mL of water and 0.75 mL of an aqueous solution of AlCl₃ (1.44 mol L⁻ 1.08 mmol) are added. To the solution 0.938 mL (5.76 mol L⁻¹, 5.4 mmol) of diluted acetic acid and 2.7 mL (2 mol L⁻¹, 5.4 mmol) of diluted sodium hydroxide solution are added. The glass reactor is sealed and tempered in an aluminum block for 2 hours while stirring at a) 70° C., b) 80° C., c) 90° C., d) 100° C.

After cooling to room temperature, the precipitate is separated by centrifuging in 15 mL centrifuge tubes for 10 minutes at a speed of 10,000 revolutions per minute and then taken up twice with water and ethanol for washing and centrifuged again for separation. The colorless precipitate is then dried at room temperature for 12 hours.

1e) Preparation of [Al₂₄(OH)₅₆(CH₃COO)₁₂]Cl₄ in a flow reactor at 95° C.:

2.61 g (10.8 mmol) AlCl₃×6 H₂O are dissolved in 16.1 mL H2O. 9.38 mL (5.76 mol L⁻¹, 54 mmol) of diluted acetic acid and 27 mL (2 mol L⁻¹, 54 mmol) of diluted sodium hydroxide solution are added to the solution. The solution is drawn into a 60 mL syringe of a syringe pump. Subsequently, 50 mL of the solution are pumped through a PTFE tube (15 mL total volume) at a flow rate of 200 mL/h. The tube is tempered in an oil bath at 95° C.

The dispersion of the colorless product is separated by centrifugation in 15 mL centrifuge tubes for 10 minutes at a speed of 10,000 revolutions per minute and then taken up twice with water and ethanol for washing and centrifuged again for separation. The colorless precipitate is then dried at room temperature for 12 hours.

1f) Preparation of [Al₂₄(OH)₅₆(CH₃COO)₁₂]Cl₄ in 10 L Round-Bottom Flask Under Reflux (Rf):

434.6 g (1.8 mol) AlCl₃×6 H₂O are dissolved in 5 L H₂O in a 10 L-round-bottomed flask. To this solution, 4.5 L of an aqueous sodium hydroxide solution (2 mol L⁻¹, 9 mol) and 516 mL of acetic acid (9 mol) are added. The solution is heated and stirred under reflux for 2 hours. After cooling to room temperature, the supernatant clear solution is decanted and the colorless precipitate is separated by centrifugation in 15 mL centrifuge tubes for 10 minutes at a speed of 10,000 revolutions per minute. It is then taken up twice in water and ethanol for washing and centrifuged again for separation. After that, the sample is dried at room temperature for 12 hours.

1g) Preparation of [Al₂₄(OH)₅₆(CH₃COO)₁₂]Cl₄ in a 30 mL Steel Autoclave Under Hydrothermal Conditions:

In a 30 mL Teflon vessel, 2.15 mL of water and 1 mL of an aqueous solution of AlCl₃ (1.44 mol L⁻¹, 1.44 mmol) are added. To the solution are added 1.25 mL (5.76 mol L⁻¹, 7.2 mmol) of diluted acetic acid and 3.6 mL (2 mol L⁻¹, 7.2 mmol) of diluted sodium hydroxide solution. The Teflon insert is sealed with a Teflon lid and placed in a steel autoclave. The sealed steel autoclave is then tempered in an oven for 30 hours at 140° C.

After cooling to room temperature, the precipitate is separated by centrifuging in 15 mL centrifuge tubes for 10 minutes at a speed of 10,000 revolutions per minute and then added to water and ethanol twice for washing and centrifuged again for separation. The colorless precipitate is then dried at room temperature for 12 hours.

1h) Preparation of [Al₂₄(OH)₅₆(CH₃COO)₁₂]Cl₄ in an Erlenmeyer Flask at Room Temperature:

In a 50 mL Erlenmeyer flask, 8.6 mL of water and 4 mL of an aqueous solution of AlCl₃ (1.44 mol L⁻¹, 5.76 mmol) are added. To the solution are added 5 mL (5.76 mol L⁻¹, 28.8 mmol) of diluted acetic acid and 14.4 mL (2 mol L⁻¹, 28.8 mmol) of diluted sodium hydroxide solution.

The Erlenmeyer flask is sealed with a stopper and left to stand for 4 weeks at room temperature (25° C.).

The precipitate is separated by centrifuging in 15 mL centrifuge tubes for 10 minutes at a speed of 10,000 revolutions per minute and then taken up twice with water and ethanol for washing and centrifuged again for separation. The colorless precipitate is then dried at room temperature for 12 hours.

2) Preparation of [Al₂₄(OH)₅₆(CH₃COO)₁₂]Br₄ in a 14 mL Duran® Glass Reactor at 90° C.:

In a 14 mL Duran® glass reactor, 2 mL of water and 3 mL of an aqueous solution of NaAlO₂ (0.36 mol L⁻¹, 1.08 mmol) are added. 0.75 mL of diluted acetic acid (5.76 mol L⁻¹, 4.32 mmol) is added to the solution. Then 0.27 mL of an aqueous solution of NaBr (4 mol L⁻¹, 1.08 mmol) is added. The glass reactor is sealed and tempered in an aluminum block for 2 hours at 90° C. while stirring.

After cooling to room temperature, the precipitate is separated by centrifuging in 15 mL centrifuge tubes for 10 minutes at a speed of 10,000 revolutions per minute and then added to water and ethanol twice for washing and centrifuged again for separation. The colorless precipitate is then dried at room temperature for 12 hours.

3) Preparation of [Al₂₄(OH)₅₆(CH₃COO)₁₂]I₄ in a 14 mL Duran® Glass Reactor at 90° C.:

In a 14 mL Duran® glass reactor, 2 mL of water and 3 mL of an aqueous solution of NaAlO₂ (0.36 mol L⁻¹, 1.08 mmol) are added 0.75 mL of diluted acetic acid (5.76 mol L⁻¹, 4.32 mmol) is added to the solution. Then 0.27 mL of an aqueous solution of NaI (4 mol L⁻¹, 1.08 mmol) is added. The glass reactor is sealed and tempered in an aluminum block for 2 hours at 90° C. while stirring.

After cooling to room temperature, the precipitate is separated by centrifuging in 15 mL centrifuge tubes for 10 minutes at a speed of 10,000 revolutions per minute and then added to water and ethanol twice for washing and centrifuged again for separation. The colorless precipitate is then dried at room temperature for 12 hours.

4) Preparation of [Al₂₄(OH)₅₆(CH₃COO)₁₂](OH)₄ in a 14 mL Duran® Glass Reactor at 90° C.:

In a 14 mL Duran® glass reactor, 2.25 mL of water and 3 mL of an aqueous solution of NaAlO₂ (0.36 mol L⁻¹, 1.08 mmol) are added. 0.75 mL of diluted acetic acid (5.76 mol L⁻¹, 4.32 mmol) is added to the solution. The glass reactor is sealed and tempered in an aluminum block for 2 hours at 90° C. while stirring.

After cooling to room temperature, the precipitate is separated by centrifugation in 15 mL centrifuge tubes for 10 minutes at a speed of 10,000 revolutions per minute and then resuspended twice in water and ethanol for washing and centrifuged again for separation. The colorless precipitate is then dried at room temperature for 12 hours.

5) Preparation of [Al₂₄(OH)₅₆(CH₃COO)₁₂](SCN)₄ in a 14 mL Duran® Glass Reactor at 90° C.:

In a 14 mL Duran® glass reactor, 2.73 mL of water and 2.25 mL of an aqueous solution of NaAlO₂ (0.36 mol L⁻¹, 0.81 mmol) are added. 0.75 mL of diluted acetic acid (5.76 mol L⁻¹, 4.32 mmol) is added to the solution. Subsequently, 0.27 mL of an aqueous solution of NaSCN (4 mol L⁻¹, 1.08 mmol). The glass reactor is sealed and tempered in an aluminum block for 2 hours at 90° C. while stirring.

After cooling to room temperature, the precipitate is separated by centrifuging in 15 mL centrifuge tubes for 10 minutes at a speed of 10,000 revolutions per minute and then added to water and ethanol twice for washing and centrifuged again for separation. The colorless precipitate is then dried at room temperature for 12 hours.

6) Preparation of [Al₂₄(OH)₅₆(CH₃COO)₁₂](NO₃)₄ in a 14 mL Duran® Glass Reactor at 90° C.:

In a 14 mL Duran® glass reactor, 1.6 mL of water and 0.75 mL of an aqueous solution of Al(NO₃)₃ (1.44 mol L⁻¹, 1.08 mmol) are added. 0.938 mL (5.76 mol L⁻¹, 5.4 mmol) of diluted acetic acid and 2.16 mL (2 mol L⁻¹, 4.32 mmol) of diluted sodium hydroxide solution are added to the solution. The glass reactor is sealed and tempered in an aluminum block for 2 hours while stirring at 90° C.

After cooling to room temperature, the precipitate is separated by centrifugation in 15 mL centrifuge tubes for 10 minutes at a speed of 10,000 revolutions per minute and then taken up twice with water and ethanol for washing and centrifuged again for separation. The colorless precipitate is then dried at room temperature for 12 hours.
7) Preparation of [Al₂₄(OH)₅₆(CH₃COO)₁₂](HSO₄)₄ in a 14 mL Duran® glass reactor at 90° C.: In a 14 mL Duran® glass reactor, 1.6 mL of water and 0.75 mL of an aqueous solution of Al₂(SO₄)₃(0.72 mol L⁻¹, 0.54 mmol) are added. 0.75 mL (5.76 mol L⁻¹, 4.32 mmol) of diluted acetic acid and 2.7 mL (2 mol L⁻¹, 5.4 mmol) of diluted sodium hydroxide solution are added to the solution. The glass reactor is sealed and tempered in an aluminum block for 2 hours at 90° C. while stirring.

After cooling to room temperature, the precipitate is separated by centrifuging in 15 mL centrifuge tubes for 10 minutes at a speed of 10,000 revolutions per minute and then added twice to water and ethanol for washing and centrifuged again for separation. The colorless precipitate is then dried at room temperature for 12 hours.

8) Preparation of [Al₂₄(OH)₅₆(CH₃COO)₁₂](HS)₄ in a 14 mL Duran® Glass Reactor at 90° C.:

In a 14 mL Duran® glass reactor, 2.73 mL of water and 2.25 mL of an aqueous solution of NaAlO₂ (0.36 mol L⁻¹, 0.81 mmol) are added 0.75 mL of diluted acetic acid (5.76 mol L⁻¹, 4.32 mmol) is added to the solution. Subsequently, 0.27 mL of an aqueous solution of Na₂S (2 mol L⁻¹, 0.54 mmol) is added. The glass reactor is sealed and tempered in an aluminum block for 2 hours at 90° C. while stirring.

After cooling to room temperature, the precipitate is separated by centrifuging in 15 mL centrifuge tubes for 10 minutes at a speed of 10,000 revolutions per minute and then taken up twice in water and ethanol for washing and centrifuged again for separation. The colorless precipitate is then dried at room temperature for 12 hours.

9) Preparation of [Al₂₄(OH)₅₆(CH₃COO)₁₂](ClO₃)₄ in a 14 mL Duran® Glass Reactor at 90° C.:

In a 14 mL Duran® glass reactor, 2 mL of water and 3 mL of an aqueous solution of NaAlO₂ (0.36 mol L⁻¹, 1.08 mmol) are added. 0.75 mL of diluted acetic acid (5.76 mol L⁻¹, 4.32 mmol) is added to the solution. Subsequently, 0.27 mL of an aqueous solution of NaClO₃ (4 mol L⁻¹, 1.08 mmol) is added. The glass reactor is sealed and tempered in an aluminum block for 2 hours at 90° C. while stirring.

After cooling to room temperature, the precipitate is separated by centrifuging in 15 mL centrifuge tubes for 10 minutes at a speed of 10,000 revolutions per minute and then added to water and ethanol twice for washing and centrifuged again for separation. The colorless precipitate is then dried at room temperature for 12 hours.

10) Preparation of [Al₂₄(OH)₅₆(CH₃COO)₁₂](ClO₄)₄ in a 14 mL Duran® Glass Reactor at 90° C.:

In a 1 4 mL Duran® glass reactor, 2.12 mL of water and 3 mL of an aqueous solution of NaAlO₂ (,36 mol L⁻¹, 1.08 mmol) are added. 0.75 mL of diluted acetic acid (5.76 mol L⁻¹, 4.32 mmol) is added to the solution. Subsequently, 0.135 mL of an aqueous solution of NaClO₄ (4 mol L⁻¹, 0.54 mmol) is added. The glass reactor is sealed and tempered in an aluminum block for 2 hours at 90° C. while stirring.

After cooling to room temperature, the precipitate is separated by centrifuging in 15 mL centrifuge tubes for 10 minutes at a speed of 10,000 revolutions per minute and then taken up twice with water and ethanol for washing and centrifuged again for separation. The colorless precipitate is then dried at room temperature for 12 hours.

11) Preparation of [Al₂₄(OH)₅₆(C₂H₅COO)₁₂]Cl₄ in a 14 mL Duran® Glass Reactor at 90° C.:

In a 14 mL Duran® glass reactor, 2.88 mL of water and 0.75 mL of an aqueous solution of AlCl₃ (1.44 mol L⁻¹, 1.08 mmol) are added. 0.75 mL (2.88 mol L⁻¹, 2.16 mmol) of diluted propionic acid and 1.62 mL (2 mol L⁻¹, 3.24 mmol) of diluted sodium hydroxide solution are added to the solution. The glass reactor is sealed and tempered in an aluminum block for 2 hours at 90° C. while stirring.

After cooling to room temperature, the precipitate is separated by centrifuging in 15 mL centrifuge tubes for 10 minutes at a speed of 10,000 revolutions per minute and then added to water and ethanol twice for washing and centrifuged again for separation. The colorless precipitate is then dried at room temperature for 12 hours.

12) Preparation of [Al₂₄(OH)₅₆(HCOO)ₓ(CH₃COO)₁₂₋ₓ]Cl₄ with x=1,2 in a 14 mL Duran® Glass Reactor at 90° C.:

In a 14 mL Duran® glass reactor, 1.97 mL of water and 0.75 mL of an aqueous solution of AlCl₃ (1.44 mol L⁻¹, 1.08 mmol) are added. 0.75 mL (5.76 mol L⁻¹, 4.32 mmol) of diluted acetic acid, 0.375 mL (2.88 mol L⁻¹, 1.08 mmol) of diluted formic acid, and 2.7 mL (2 mol L⁻¹, 5.4 mmol) of diluted sodium hydroxide solution are added to the solution. The glass reactor is sealed and tempered in an aluminum block for 2 hours at 90° C. while stirring.

After cooling to room temperature, the precipitate is separated by centrifugation in 15 mL centrifuge tubes for 10 minutes at a speed of 10,000 revolutions per minute and then resuspended in water and ethanol for washing and centrifuged again for separation. The colorless precipitate is then dried at room temperature for 12 hours.

The compound was dissolved in NaOD and D2O and the incorporation of the two carboxylate ions was demonstrated by 1H-NMR spectroscopy (FIG. 7).

13) Preparation of [Al₂₄(OH)₅₆(HSCH₂COO)₁₂]Cl₄ in a 2 mL Steel Autoclave:

In a 2 mL Teflon vessel, 296 μL of water and 250 μL of an aqueous solution of AlCl₃ (1.44 mol L⁻¹, 0.36 mmol) are added. 94 μL (5.76 mol L⁻¹, 0.54 mmol) of diluted thioglycolic acid and 360 μL (2 mol L⁻¹, 0.72 mmol) of diluted sodium hydroxide solution are added to the solution. The Teflon insert is sealed with a Teflon lid and placed in a steel autoclave. The sealed steel autoclave is then tempered in an oven for 50 hours at 100° C.

After cooling to room temperature, the precipitate is separated by centrifuging in 2 mL centrifuge tubes for 5 minutes at a speed of 10,000 revolutions per minute and then added to water and ethanol twice for washing and centrifuged again for separation. After that, the colorless precipitate is dried at room temperature for 12 hours.

14a) Preparation of [Al₂₄(OH)₅₆(CH₃COO)₁₂]Cl_{1,3}Br_{2,7} in a 14 mL Duran® Glass Reactor at 90° C.:

In 2.2 mL of water and 3 mL of an aqueous solution of NaAlO₂ (0.36 mol L⁻¹, 1.08 mmol) are placed in a 14 mL Duran® glass reactor. 0.75 mL of diluted acetic acid (5.76 mol L⁻¹, 4.32 mmol) is added to the solution. After that, 13.5 μL of an aqueous NaCl solution (4 mol L⁻¹, 54 mol) and 40.5 μL of an aqueous NaBr solution (4 mol L⁻¹, 162 mmol) are added. The glass reactor is sealed and tempered in an aluminum block for 2 hours at 90° C. while stirring.

After cooling to room temperature, the precipitate is separated by centrifuging in 15 mL centrifuge tubes for 10 minutes at a speed of 10,000 revolutions per minute and then added to water and ethanol twice for washing and centrifuged again for separation. After that, the colorless precipitate is dried at room temperature for 12 hours.

14b) Preparation of [Al₂₄(OH)₅₆(CH₃COO)₁₂]Cl_{2,3}Br_{1,7} in a 14 mL Duran® Glass Reactor at 90° C.:

In 2.2 mL of water and 3 mL of an aqueous solution of NaAlO₂ (0.36 mol L⁻¹, 1.08 mmol) are placed in a 14 mL Duran® glass reactor. 0.75 mL of diluted acetic acid (5.76 mol L⁻¹, 4.32 mmol) is added to the solution. Then 27 μL of an aqueous solution of NaCl (4 mol L⁻¹, 108 mol) and 27 μL of an aqueous solution of NaBr (4 mol L⁻¹, 108 mmol) are added.

After cooling to room temperature, the precipitate is separated by centrifuging in 15 mL centrifuge tubes for 10 minutes at a speed of 10,000 revolutions per minute and then added to water and ethanol twice for washing and centrifuged again for separation. The colorless precipitate is then dried at room temperature for 12 hours.

14c) Preparation of [Al₂₄(OH)₅₆(CH₃COO)₁₂]Cl₃Br Cl₃Br in a 14 mL Duran® Glass Reactor at 90° C.:

In a 14 mL Duran® glass reactor, 2.2 mL of water and 3 mL of an aqueous solution of NaAlO₂ (0.36 mol L⁻¹, 1.08 mmol) are added. 0.75 mL of diluted acetic acid (5.76 mol L⁻¹, 4.32 mmol) is added to the solution. Then 40.5 μL of an aqueous solution of NaCl (4 mol L⁻¹, 162 μmol) and 13.5 μL of an aqueous solution of NaBr (4 mol L⁻¹, 54 mmol) are added. The glass reactor is sealed and tempered in an aluminum block for 2 hours at 90° C. while stirring.

After cooling to room temperature, the precipitate is separated by centrifuging in 15 mL centrifuge tubes for 10 minutes at a speed of 10,000 revolutions per minute and then taken up twice with water and ethanol for washing and centrifuged again for separation. The colorless precipitate is then dried at room temperature for 12 hours.

15a) Preparation of [Al₂₄(OH)₅₆(CH₃COO)₁₂]Br_{3,5}I_{0,5} in a 14 mL Duran® Glass Reactor at 90° C.:

In 2.2 mL of water and 3 mL of an aqueous solution of NaAlO₂ (0.36 mol L⁻¹, 1.08 mmol) are placed in a 14 mL Duran® glass reactor. 0.75 mL of diluted acetic acid (5.76 mol L⁻¹, 4.32 mmol) are added to the solution. Then 13.5 μL of an aqueous solution of NaBr (4 mol L⁻¹, 54 μmol) and 40.5 μL of an aqueous solution of NaI (4 mol L⁻¹, 162 mmol) are added. The glass reactor is sealed and tempered in an aluminum block for 2 hours at 90° C. while stirring. After cooling to room temperature, the precipitate is separated by centrifuging in 15 mL centrifuge tubes for 10 minutes at a speed of 10,000 revolutions per minute and then, for washing, it is added to twice with water and ethanol and centrifuged again for separation. The colorless precipitate is then dried at room temperature for 12 hours.

15b) Preparation of [Al₂₄(OH)₅₆(CH₃COO)₁₂]Br_{3,7}I_{0,3} in a 14 mL Duran®-Glass Reactor at 90° C.:

In a 14 mL Duran® glass reactor, 2.2 mL of water and 3 mL of an aqueous solution of NaAlO₂ (0.36 mol L⁻¹, 1.08 mmol) are added. 0.75 mL of diluted acetic acid (5.76 mol L⁻¹, 4.32 mmol) are added to the solution. Then 27 μL of an aqueous solution of NaBr (4 mol L⁻¹, 108 μmol) and 27 μL of an aqueous solution of NaI (4 mol L⁻¹, 108 mmol). The glass reactor is sealed and tempered in an aluminum block for 2 hours at 90° C. while stirring.

After cooling to room temperature, the precipitate is separated by centrifugation in 15 mL centrifuge tubes for 10 minutes at a speed of 10,000 revolutions per minute and then added to water and ethanol twice for washing and centrifuged again for separation. The colorless precipitate is then dried at room temperature for 12 hours.

### Dye Experiments:

The new compounds [Al₂₄(OH)₅₆(RCOO)₁₂]X₄ are very suitable as anion adsorbents due to their structure and high positive surface charge. For example, anionic dyes can be quickly and effectively removed from ethanolic and aqueous solutions by adsorption. Accordingly, the compounds could also be suitable as a substrate for the production of pigments.

7.2 mg [Al₂₄(OH)₅₆(RCOO)₁₂](HSO₄)₄(2 μmol)) are dispersed in 1 mL of water. 1 mL of an aqueous colored solution of Alizarin red S (1 mmol L⁻¹, 2 mol) is added to the dispersion and stirred for 2 hours at room temperature. The red precipitate was separated from the colorless solution by centrifuging in a 2 mL centrifuge tube for 2 minutes at a speed of 9,000 revolutions per minute. It was then resuspended in water twice to wash it and centrifuged again to separate it. After that, the red precipitate was dried at 50° C. for 12 hours.

### LIST OF FIGURES

FIG. 1: Structure of the cationic cages, 1a trinuclear unit of the composition {Al₃(μ₃—OH)(μ₂—OH)₃^{}5+}. Eight of these trinuclear units are linked via 24 OH⁻ und 12 CH₃COO— Ions(1b), wherein a cationic cage of the composition [Al₂₄(OH)₅₆(CH₃COO)₁₂^{]4+} is formed (1c).

FIG. 2: Arrangement of the cationic cages in the unit cell (internally centered cubic packing). The edges of the unit cell are shown in black.

FIG. 3: X-ray powder diffractograms of the compounds according to the invention [Al₂₄(OH)₅₆(RCOO)₁₂]X₄ with R═CH₃ {X=Cl⁻ (1), Br⁻ (2), I⁻ (3), OH⁻ (4) SCN⁻ (5) NO₃⁻ (6), HSO₄⁻ (7), HS⁻ (8), ClO₃⁻ (9), ClO₄⁻ (10)}, R═C₂H₅ {X=Cl⁻}(11) und R═H/CH₃ {X=Cl⁻}(12), R═—CH₂SH {X=Cl⁻}(13)

FIG. 4: X-ray powder diffractograms of the compounds according to the invention [Al₂₄(OH)₅₆(CH₃COO)₁₂]Cl_{y}Br_{4-y} with y=1,3 (14a); 2.3 (14b); 3 (14c).

FIG. 5: X-ray powder diffractograms of the compounds according to the invention [Al₂₄(OH)₅₆(CH₃COO)₁₂]BrₓI₄₋ₓ with x=3.5 (15a); 3.7 (15b).

FIG. 6: X-ray powder diffractograms of the compound according to the invention [Al₂₄(OH)₅₆(CH₃COO)₁₂]Cl₄ produced under different reaction conditions (reaction temperatures and reaction vessels).

FIG. 7: NMR spectrum of [Al₂₄(OH)₅₆(HCOO)ₓ(CH₃COO)₁₂₋ₓ]Cl₄ (12)

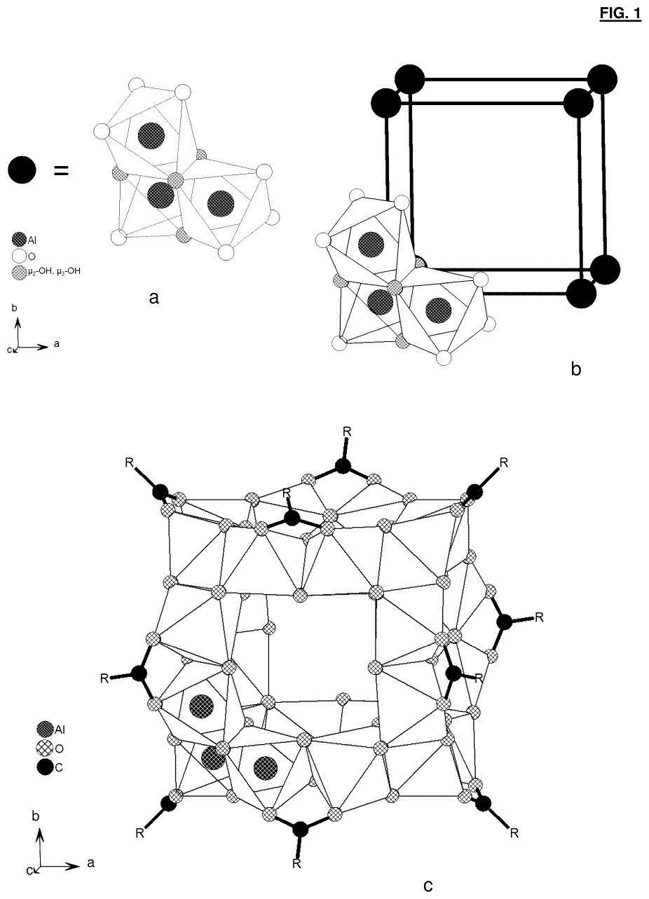

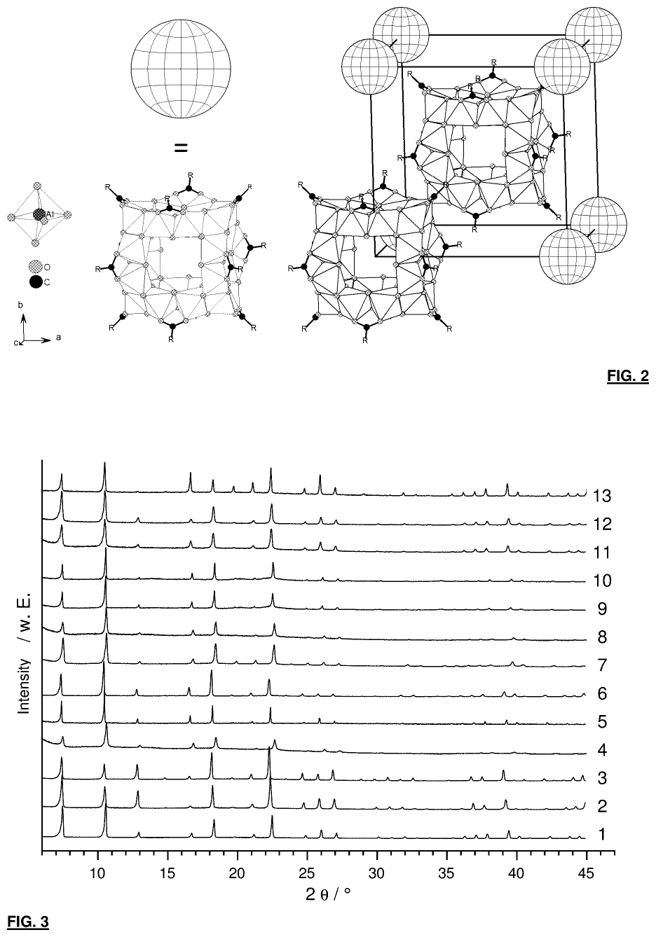

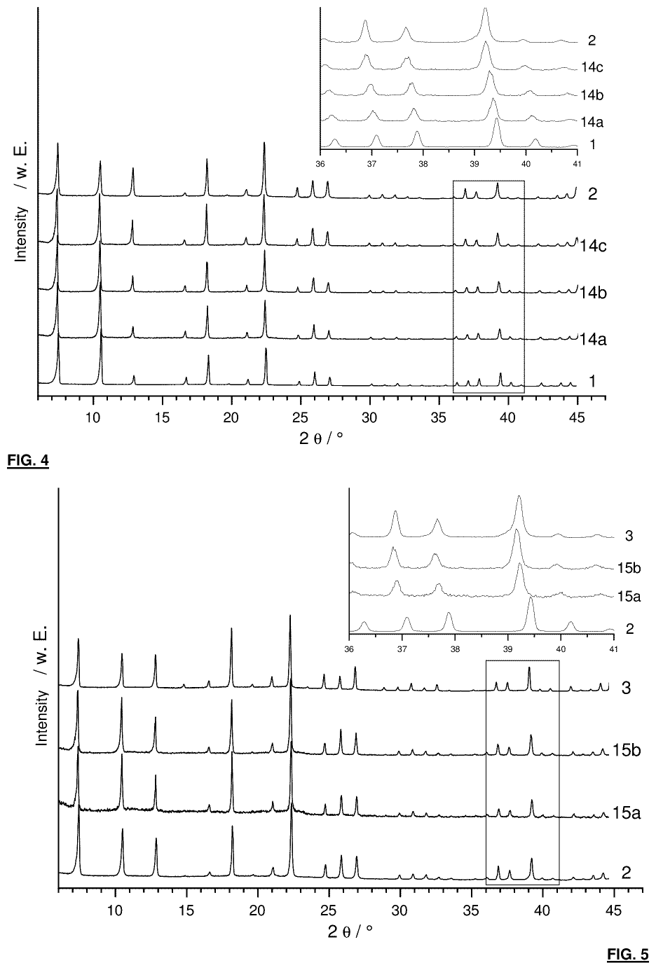

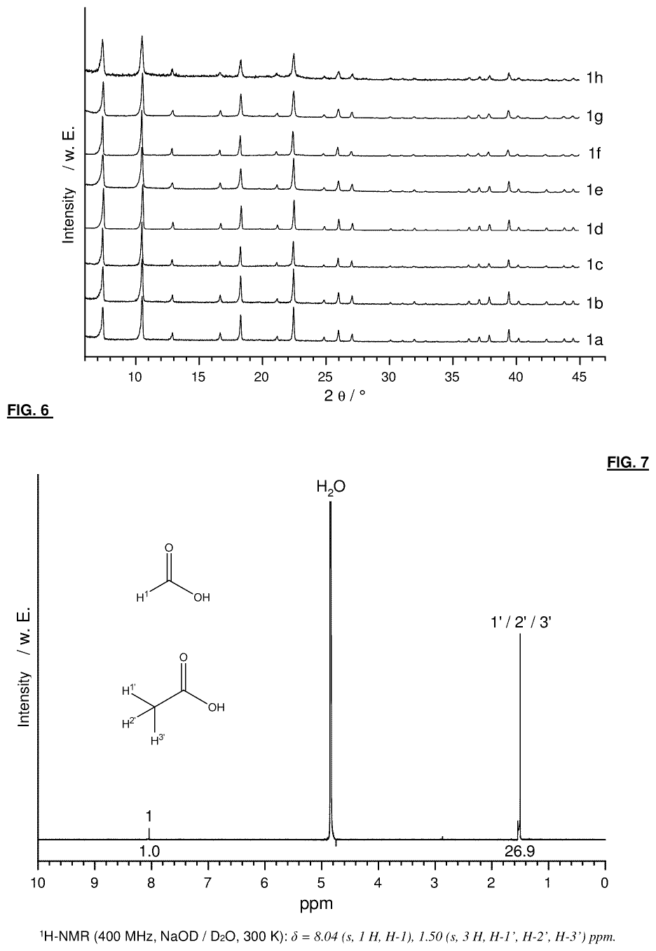

1. A porous crystalline compound according to the following formula: [Al₂₄(OH)₅₆(RCOO)₁₂]X₄ wherein R may be hydrogen or a branched or unbranched, saturated or unsaturated, functionalized or non-functionalized hydrocarbon chain having a length of 1 to 8 carbon atoms and wherein the functionalization is selected from the group —OH, —F, —Cl, —Br, —I, —SH, −NO₂, —CHO, —COOH, —SO₃H, —NH₂ and wherein R can be the same or different and wherein X can be the same or different and wherein X is an anion, preferably a monovalent anion, particularly preferably a monovalent anion selected from the group Cl⁻, Br⁻, I⁻, OH⁻, SCN⁻, NO₃⁻, HSO₄⁻, HS⁻, ClO₃⁻, and ClO₄⁻ or mixtures of these anions.

2. The porous crystalline compound according to claim 1, wherein the compound contains cationic [Al₂₄(OH)₅₆(RCOO)₁₂^{]4+}-cages, which consist of 8 trinuclear building units of the composition {Al₃(μ₃OH)(μ₂—OH)₃^{}5+}, 24 OH⁻ and 12 RCOO⁻ ions, each of the three aluminum cations Al³⁺ being coordinated octahedrally coordinated octahedrally by 5 OH⁻ and one RCOO⁻ via the oxygen atom and the {Al₃(μ₃—OH)(μ₂—OH)₃}⁵⁺-building units are arranged on the corners of a cube and adjacent {Al₃(μ₃—OH)(μ₂—OH)₃^{}5+}-building units are linked in each case by 2 OH⁻ and 1 RCOO⁻.

3. The porous crystalline compound according to claim 2, wherein the cationic [Al₂₄(OH)₅₆(RCOO)₁₂^{]4+}-are arranged in body-centered cubic manner.

4. The porous crystalline compound according to claim 1, wherein the anions are monovalent anions.

5. The porous crystalline compound according to claim 4, wherein the anions are selected from the group consisting of Cl⁻, Br⁻, I⁻, OH⁻, SCN⁻, NO₃⁻, HSO₄⁻, HS⁻, ClO₃⁻, und ClO₄⁻.

6. The porous crystalline compound according to claim 4, wherein monovalent anions occupy ⅔ of the octahedrally arranged free sites, which result from the face-centered cubic arrangement of the cationic [Al₂₄(OH)₅₆(RCOO)₁₂^{]4+}-cages.

7. The porous crystalline compound according to claim 1, wherein it is selected from the group consisting of [Al₂₄(OH)₅₆(CH₃COO)₁₂]Cl₄, [Al₂₄(OH)₅₆(CH₃COO)₁₂]Br₄, [Al₂₄(OH)₅₆(CH₃COO)₁₂]I₄, [Al₂₄(OH)₅₆(CH₃COO)₁₂](OH)₄, [Al₂₄(OH)₅₆(CH₃COO)₁₂](SCN)₄, [Al₂₄(OH)₅₆(CH₃COO)₁₂](NO₃)₄, [Al₂₄(OH)₅₆(CH₃COO)₁₂](HSO₄)₄, [Al₂₄(OH)₅₆(CH₃COO)₁₂](HS)₄, [Al₂₄(OH)₅₆(CH₃COO)₁₂](ClO₃)₄, [Al₂₄(OH)₅₆(CH₃COO)₁₂](ClO₄)₄, [Al₂₄(OH)₅₆(C₂H₅COO)₁₂]Cl₄, [Al₂₄(OH)₅₆(HCOO)ₓ(CH₃COO)₁₂₋ₓ]Cl₄ with x=1; 2, [Al₂₄(OH)₅₆(HSCH₂COO)₁₂]Cl₄, [Al₂₄(OH)₅₆(CH₃COO)₁₂]Cl_{y}Br_{4-y} with y=0 to 4, [Al₂₄(OH)₅₆(CH₃COO)₁₂]Br_{y}I_{4-y} with y=0 to 4.

8. A method for producing porous crystalline compounds according to claim 1, comprising the steps of:
i. providing an aqueous solution of an aluminum salt;
ii. adding the carboxylic acid or the mixture of carboxylic acids or their salts;
iii. optionally adding a water-soluble salt of the anion or the mixture of different anions X;
iv. tempering the mixture from step iii at RT to 140° C. for 4 weeks to 2 minutes;
v. optionally, allowing the mixture to cool to room temperature;
vi. separating the solid from the solution, for example by filtering, spray drying or centrifugation;
vii. washing the resulting solid with water and/or alcohols;
viii. drying the washed solid.

9. The method according to claim 8, wherein the anions X are selected from the group:
Cl⁻, Br⁻, I⁻, OH⁻, SCN⁻, NO₃⁻, HSO₄⁻, HS⁻, ClO₃⁻, and ClO₄⁻ or mixtures thereof.

10. An adsorbent for anions comprising a porous crystalline compound according to claim 1.

11. Use of a porous crystalline compound according to claim 1.

12. A method for the separation of gases or liquids comprising exposing the gasses or liquids to a porous crystalline compound according to claim 1 followed by separation of gases or liquids.

13. A filler for a porous membrane comprising a porous crystalline compound as claimed in claim 1.

14. A coating material comprising a porous crystalline compound according to claim 1.

15. An aluminum oxide or aluminum hydroxide comprising a porous crystalline compound according to claim 1.

16. A metal-organic framework compound comprising a porous crystalline compound according to claim 1.
